(19) United States
(12) Patent Application Publication
(10) Pub. No.: US 2015/0071649 A1
(43) Pub. Date: Mar. 12, 2015

(54) DETACHABLE OPTICAL TRANSCEIVER

(71) Applicant: Electronics and Telecommunicatons Research Institute, Daejeon (KR)

(72) Inventors: JIE HYUN LEE, Daejeon (KR); SEUNG HYUN CHO, Daejeon (KR); KYEONG HWAN DOO, Daejeon (KR); SEUNG IL MYONG, Daejeon (KR)

(21) Appl. No.: 14/480,729

(22) Filed: Sep. 9, 2014

(30) Foreign Application Priority Data
Sep. 11, 2013 (KR) 10-2013-0109341

(51) Int. Cl. H04B 10/40; H04B 10/2575; H04B 10/25

(52) U.S. Cl. CPC H04B 10/40; H04B 10/2503; H04B 10/2575
USPC 398/135

(57) ABSTRACT

A detachable optical transceiver includes an optical part configured to convert an electric signal into an optical signal and transmit the optical signal, or to convert an optical signal into an electric signal and output the electric signal; and an electronic circuit part configured to amplify an electric signal input from a host board and output the amplified electric signal to the optical part, and to amplify an electric signal output from the optical part and output the amplified electric signal to the host board, wherein the optical part and the electronic circuit part are formed to have housings and the optical part and the electronic circuit part are connected and disconnected via connectors formed on the respective housings.

### CROSS-REFERENCE TO RELATED APPLICATION(S)

This application claims priority from Korean Patent Application No. 10-2013-0109341, filed on Sep. 11, 2013, in the Korean Intellectual Property Office, the disclosure of which is incorporated herein by reference in its entirety.

### BACKGROUND

1. Field

The following description relates to an optical transceiver, and more particularly, to a detachable optical transceiver with a detachable part for performing optical processing.

2. Description of the Related Art

With the advent of smart devices, such as smart phones, smart TVs, and the like, an excess amount of traffic results in wired and wireless networks. Many researches on the application of a wavelength division multiplexing-based technology to a cable subscriber network or a wired-wireless integrated network to effectively cope with such traffic issues has been conducted.

Wavelength division multiplexing (WDM) is a technology which multiplexes a number of optical wavelengths and transmits and receives the multiplexed signals over a single strand of fiber. The WDM technology can reduce the cost for paths in proportion to the number of optical wavelengths supported by one strand of fiber, and as separating channels by light wavelengths, WDM can have more advantages in terms of security, quality of service (QoS), and protocol transparency, in comparison with other technologies.

However, to exploit the WDM technology, a different wavelength needs to be assigned to each optical network unit to enable the communication, and thus as many optical transceivers with their own unique wavelengths are required as the number of subscribers to a cable subscriber network branched by a remote node or as the number of separated base stations used in a wired-wireless integrated network.

Requiring different types of unique wavelength optical transceivers may mean that multiple particular optical transceivers with different wavelengths should be produced, installed, maintained, and prepared in anticipation of any defects. This may be a great burden to network service providers.

Therefore, to alleviate such load for the service providers, research and development on colorless optical transceiver have been actively carried out. An optical transceiver with a reflective light source, such as a reflective semiconductor optical amplifier or a Fabry-Perot laser diode, and an optical transceiver with wavelength-variable light source are used as representative colorless optical transceivers.

The optical transceiver with a reflective light source has a drawback that the quality of signal transmission is dependent on the type and optical power of light externally injected. On the other hand, the wavelength-variable optical transceiver with a wavelength-variable light source uses heat, electricity, physical force as variables, thereby producing a light output with a wavelength varying depending on a control value. A control value needs to be mapped for each light output wavelength in advance. Further, technology to monitor and control an output wavelength needs to be applied and the wavelength-variable optical transceiver is expensive to use in a subscriber network.

As another method of implementing an optical transceiver with various types of unique wavelengths, a wavelength selector that decides an output wavelength of laser is configured to be detachable by separating it from an external resonant laser that comprises a gain medium and the wavelength selector. However, in this method, the resonance characteristics of the external resonant laser may be altered according to the conditions in which the wavelength selector is detached and attached, and there are several prerequisites to be addressed in terms of reliability of the light source, which impedes the commercialization.

As for the above reasons, an optical transceiver using a light source, such as a distributed feedback (DFB) laser diode or VCSEL, which has a fixed wavelength, is currently generally used, and if the output wavelength needs to be changed, an optical transceiver may be replaced with an appropriate one. The replacement of optical transceiver may be needed in following cases: where temperature control for an optical module is required due to a change in precision conditions of an output wavelength of an optical transceiver. Where there is a need for change in an output wavelength of the optical transceiver. Where an optical detector of an optical receiver within the optical transceiver needs to be replaced or an optical transmitter needs to be replaced with a new optical transmitter with a different optical power, due to the change in a transmission distance. Where a different data transfer speed is required so that an optical receiver equipped with a pre-amplifier having a frequency response characteristic conforming to the data transfer speed is needed or an optical transmitter with a frequency response characteristic satisfying the requirement is needed. Where the optical transceiver has a degraded part, resulting in a failure to meet the system performance requirements, and thus the part of the optical transceiver needs to be replaced.

### SUMMARY

The following description relates to a detachable optical transceiver including detachable optical transmitting and receiving parts and a detachable electronic circuit part, and being capable of being configured to selectively include an optical part that meets performance requirements of a network or system.

In one general aspect, there is provided a detachable optical transceiver including: an optical part configured to convert an electric signal into an optical signal and transmit the optical signal, or to convert an optical signal into an electric signal and output the electric signal; and an electronic circuit part configured to amplify an electric signal input from a host board and output the amplified electric signal to the optical part, and to amplify an electric signal output from the optical part and output the amplified electric signal to the host board, wherein the optical part and the electronic circuit part are formed to have housings and the optical part and the electronic circuit part are connected and disconnected via connectors formed on the respective housings.

Other features and aspects will be apparent from the following detailed description, the drawings, and the claims.

### BRIEF DESCRIPTION OF THE DRAWINGS

FIG. 1 is a diagram illustrating a general optical transceiver.

FIGS. 2A and 2B are diagrams illustrating an exterior of the general optical transceiver of FIG. 1.

FIG. 3 is a diagram illustrating an exterior of a detachable optical transceiver according to an exemplary embodiment.

FIG. 4 is a diagram illustrating a configuration of the detachable optical transceiver of FIG. 3.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

An optical transceiver referred to in the following description may be in the form defined by MSA standards, such as 10 Gigabit Small Form Factor Pluggable (XFP), Small-Form-Factor Pluggable (SFP), Small-Form-Factor (SFF), Gigabit Interface Converter (GBIC), X2, XENPAK, and the like, or be

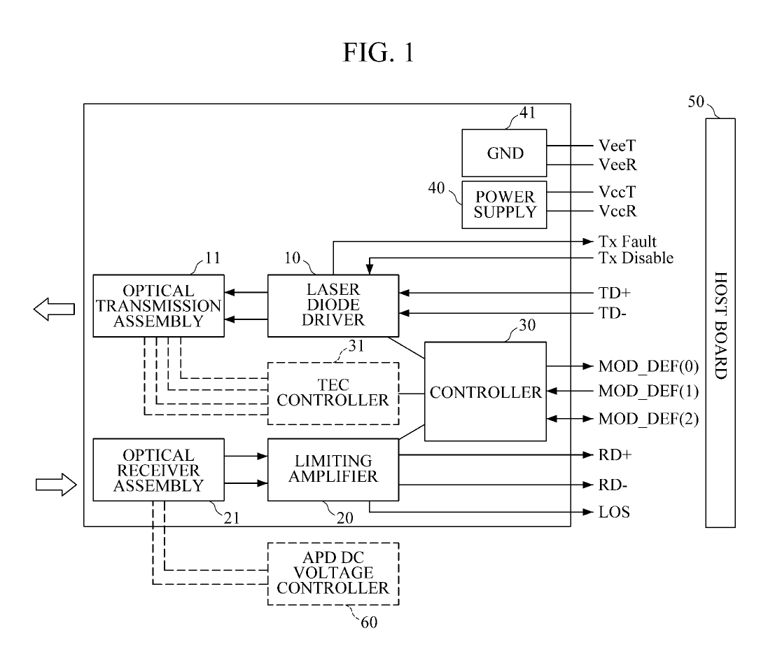

FIG. 1 is a diagram illustrating a general optical transceiver.

Referring to FIG. 1, the optical transceiver may largely consist of an optical transmitting part, an optical receiving part, and a control part.

The optical transmitting part may include a laser diode (LD) driver 10 and an optical transmission assembly (e.g., Transmit Optical Sub-Assembly (TOSA) 11. The optical receiving part may include a limiting amplifier 20 and an optical receiver assembly (e.g., Receive Optical Sub-Assembly (ROSA)) 21 equipped with a pre-amplifier. The control part may include a controller 30 and a thermo electric cooler controller (TEC controller) 31, and further include a power supply 40, a ground 41, and an avalanche photo diode (APD) direct-current (DC) voltage controller 60 for an avalanche photo diode.

When classified in a different way, the optical transmission assembly 11 and the optical receiver assembly 21 may be included in an optical part to perform optical processing, and the other elements may be classified into an electronic circuit part to control the optical part.

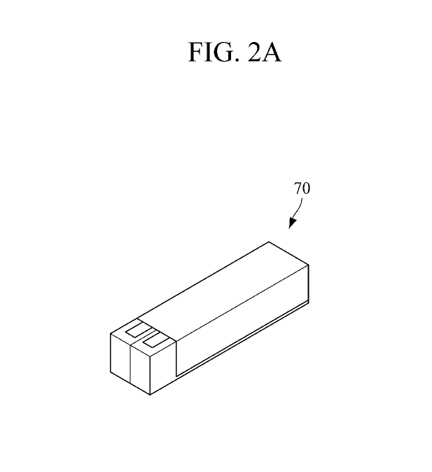

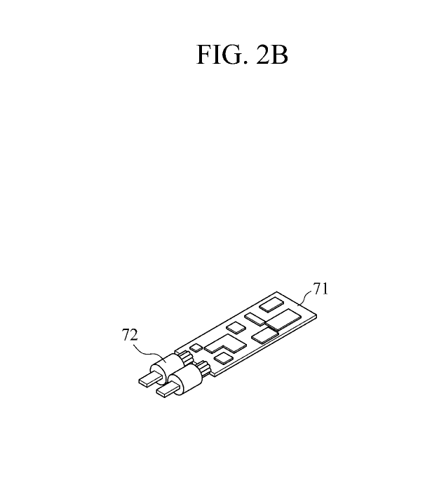

Conventionally, the optical part and the electronic circuit part are integrated into one piece. That is, an electric board integrating the electronic circuit part 71 and the optical part 72, as shown in FIG. 2B, may be mounted within a single housing 70 shown in FIG. 2A.

However, to improve the conventional optical transceiver as described above, the electronic circuit part or the housing may be commonly managed, and the optical part that determines an output wavelength may be separately configured. In other words, the optical part with optical properties which are required when building a system may be used as an optical transceiver which is detachable from the electronic circuit part.

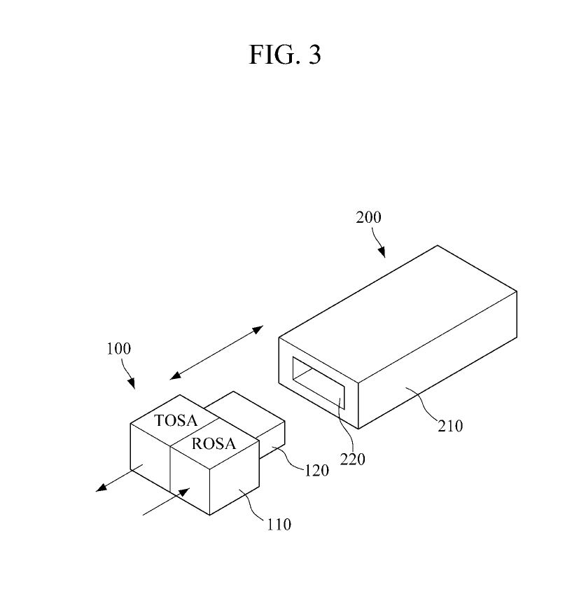

FIG. 3 is a diagram illustrating an exterior of a detachable optical transceiver according to an exemplary embodiment.

Referring to FIG. 3, the detachable optical transceiver includes an optical part 100 and the electronic circuit part 200, which have individual housings 110 and 210, respectively. A first connector 120 and a second connector 220 which are formed on the respective housings 110 and 120 allow for connecting and disconnecting between the optical part 100 and the electronic circuit part 200. The connectors 120 and 220 have frequency response properties required in a system, and the number of pins is dependent on the number of signals to be transmitted and received.

A first connector 120 may protrude from one side of the housing 110 of the optical part 100 so as to connect the optical part 100 and the housing 210 of the electronic circuit part 200, or may be formed as an insertable connector with a recess in a shape reverse to the shape illustrated in FIG. 3. Although not illustrated, for example, an elastic hook, a stopper formed on the housing of the optical part 100 to allow the optical part 100 to be elastically coupled to electronic circuit part 200 by an elastic connection with the elastic hook, and a guiding groove to guide the elastic hook to the stopper and to prevent the elastic hook to be exposed to the outside.

In one example, the first connector 120 may be formed as a flexible electronic circuit board which can be inserted in a direction toward the electronic circuit board 200.

The second connector 220 may connect the optical part 100 to one end of the housing 210 of the electronic circuit part 200 such that the optical part 100 is detachably coupled to the electronic circuit part 200. Although not illustrated, the second connector 220 may include a socket within the housing 210 of the electronic circuit part 200 into which pins extending from the optical transmission assembly and optical receiver assembly of the optical part 100 are connected, and a receiving recess may be formed on one end of the housing 210 of the electronic circuit part 200 so as to enable pins of the optical transmission and receiver assemblies equipped within the optical part 100 to be stably connected to the socket. The receiving recess may be a multi-stepwise recess to prevent the optical transmission assembly and the optical receiver assembly from moving.

In addition, the first connector 120 and the second connector 220 may be connected and disconnected only by means of a key provided to an authorized user, and a latch may be provided for this purpose.

Further, the first connector 120 and second connector 220 may have housings in asymmetric shapes in order to prevent the left and right of the connectors 120 and 220 from being switched.

The housing 110 of the optical part 100 may have a thermal resistance. For the thermal resistance, the housing may be formed of a material with good thermal resistance properties, or an individual means with thermal resistance capabilities may be added. Moreover, to improve the thermal contact, each of the first connector 120 and the second connector 220 may have a contacting portion formed of a metallic material with excellent thermal conductive properties.

Further, the contacting portion of each of the connectors may be formed as a connecting portion with a flexible printed circuit board.

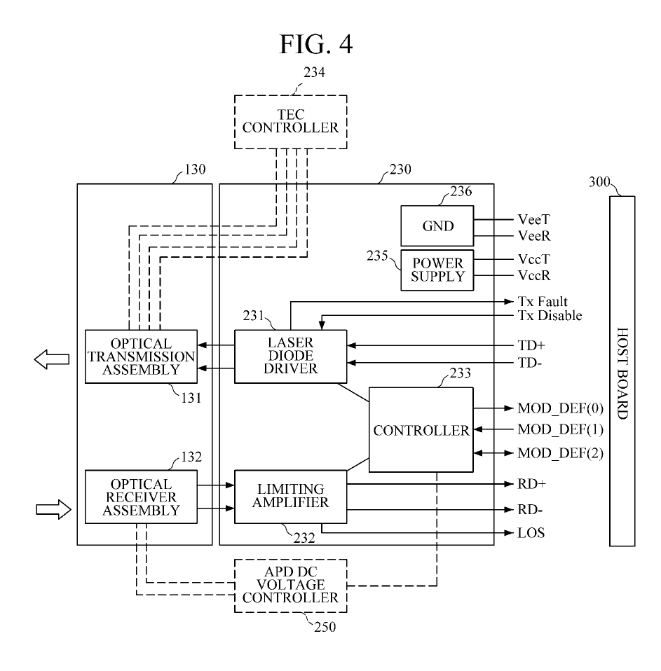

FIG. 4 is a diagram illustrating a configuration of the detachable optical transceiver of FIG. 3.

Referring to FIG. 4, an interior part 130 mounted on the optical housing 110 includes an optical transmission assembly 131 and an optical receiver assembly 132. In another example, the optical transmission assembly and the optical receiver assembly may be integrated into one entity functioning as a bidirectional optical sub-assembly (BOSA).

The optical transmission assembly 131 converts an electric signal output from the electronic circuit part 230 into an optical signal and outputs light containing the optical signal. The number of connection pins of the optical transmission assembly 131 and the optical receiver assembly 132 may be dependent on the number of electric signals to be transmitted to and received from the electronic circuit part 230.

The optical transmission assembly 131 and the optical receiver assembly 132 may each be made in the form of a pigtail or receptacle connector.

The optical transmission assembly 131 may have a single channel optical transmission module embedded therein, or an optical transmission module array embedded therein. Also, the optical receiver assembly 132 may have a signal channel optical receiver module embedded therein, or an optical receiver module array embedded therein. In a case where the optical transmission module array or the optical receiver module array is embedded in the assembly, an MPO connector may be attached to the assembly.

Additionally, the optical part 130 may previously store identification (ID) information containing driving control value information for optimal operations and output wavelength and optical power of the optical part 130, using EEPROM or the like. Further, the optical part 130 may include a slow starter-related circuit portion to enable plug-and-play even when the optical transceiver is connected to a power source by being plugged into a host board 300.

The circuit board 230 mounted within the housing 210 of the electronic circuit includes a laser diode driver 231, a limiting amplifier 232, a controller 223, a power supply 235, and a ground 236. The circuit board 230 may additionally include a thermo electric cooler controller (TEC controller) 234, and an APD DC voltage controller 250 to drive an avalanche photo diode. The additional thermo electric cooler controller 234 or the APD DC voltage controller 250 may be included in an electronic circuit part 230, or may be disposed on a separate printed circuit board (PCB), which is afterwards attached onto a top surface or a lower surface of the electronic circuit part 230. The optical driver and the limiting amplifier may be in the form of an integrated circuit. The laser diode driver and the limiting amplifier may be capable of providing a multi-rate support. The limiting amplifier may have a function to vary a decision threshold.

The controller 233 monitors whether the optical part 100 is connected to or disconnected from the electronic circuit part 200. In addition, the controller 233 controls the optical transmission assembly 131 and the optical receiver assembly 132 when the optical part 100 is connected to the electronic circuit part 200. Further, the controller 233 may report to the host board 300 as to whether the optical part 100 is connected to or disconnected from the electronic circuit part 200. For example, the controller 233 may report to the host board using a signal, for example, MOD_DEF(0).

The optical transceiver and the host board 300 may have Tx_Disable, Tx_Fault, LOS, power supply, and GND lines connected thereto, including Tx +/− and Rx +/− data signals, and may conform to particular MSA standard specifications in accordance with the purpose of the detachable optical transceiver.

The laser diode driver 231 may be included in the optical part 130 for high speed digital signal transmission.

According to the exemplary embodiments, the optical part is detachable, and thus a WDM optical transceiver can be easily manufactured and its component management is facilitated. Further, when a particular part of the optical transceiver is deteriorated, only the part needs to be replaced and the other parts of the optical transceiver can be continuously used, thereby achieving cost reduction.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A detachable optical transceiver comprising:
an optical part configured to convert an electric signal into an optical signal and transmit the optical signal, or to convert an optical signal into an electric signal and output the electric signal; and
an electronic circuit part configured to amplify an electric signal input from a host board and output the amplified electric signal to the optical part, and to amplify an electric signal output from the optical part and output the amplified electric signal to the host board,
wherein the optical part and the electronic circuit part are formed to have housings and the optical part and the electronic circuit part are connected and disconnected via connectors formed on the respective housings.

2. The detachable optical transceiver of claim 1, wherein the optical part is configured to comprise an optical transmission assembly to convert an electric signal to an optical signal and transmit the converted optical signal and an optical receiver assembly to convert an optical signal input into an electric signal and output the electric signal, wherein the optical transmission assembly and the optical receiver assembly are separate from each other.

3. The detachable optical transceiver of claim 1, wherein the optical part is configured to comprise a bidirectional integrated optical transceiver assembly to convert an electric signal into an optical signal, transmit the converted optical signal, and to convert an optical signal input into an electric signal and output the converted electric signal.

4. The detachable optical transceiver of claim 1, wherein the connectors are formed to protrude from or be recessed into one end of the housing of the optical part that is connected to the housing of the electronic circuit part, and pins of the optical part are connected into the connectors.

5. The detachable optical transceiver of claim 1, wherein the connectors have housings in asymmetric shapes.

6. The detachable optical transceiver of claim 1, wherein the housing of the optical part is made of a thermal resistant material.

7. The detachable optical transceiver of claim 1, wherein a contacting portion of each of the connectors is made of metallic material with thermal conductive properties.

8. The detachable optical transceiver of claim 1, wherein a contacting portion of each of the connectors is formed as a connecting portion with a flexible printed circuit board.

9. The detachable optical transceiver of claim 1, wherein the electronic circuit part monitors whether the optical part is connected thereto or disconnected therefrom, and provides the host board with information as to whether the optical part is connected or disconnected.

10. The detachable optical transceiver of claim 1, wherein the optical part is equipped with an optical transmission module in an array or an optical receiver module in an array.

11. The detachable optical transceiver of claim 2, further comprising:
a thermal electro cooler controller to control a temperature of the optical transmission assembly.

12. The detachable optical transceiver of claim 1, wherein the optical part is configured to comprise a laser diode driver.

13. The detachable optical transceiver of claim 1, further comprising, in a case in which an avalanche photo diode as the optical receiver assembly is used, an avalanche photo diode (APD) direct current voltage controller to control a direct current voltage of the avalanche photo diode.
